(19) United States
(12) Patent Application Publication
(10) Pub. No.: US 2006/0125770 A1
(43) Pub. Date: Jun. 15, 2006

(54) Light-merging control units

(75) Inventors: Ko-Chia Kao, Jiouru Township (TW); Chih-Kuang Chen, Kaohsiung City (TW); Jyh-Haur Huang, Hsinyuan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/040,258

(22) Filed: Jan. 21, 2005

(30) Foreign Application Priority Data
Dec. 15, 2004 (TW) 93138928

(51) Int. Cl. G09G 3/36

(52) U.S. Cl. 345/102

(57) ABSTRACT

A light-merging control unit applied in a backlight module. The backlight module comprises first and second light emitting units respectively driven by first and second frequencies. Light from the first and second light emitting units is merged into merged light. The light detector detects the merged light and generates a detection signal. The controller calculates the power of the first and second frequencies according to the detection signal. The controller controls the first driver to adjust the power of the first frequency and the second driver to adjust the power of the second frequency.

### BACKGROUND

The invention relates to backlight modules, and in particular to light-merging control units applied in backlight modules in display devices for adjusting the chromaticity coordinates of the white light.

In liquid crystal display (LCD) devices, backlight modules utilize light emitting diodes (LEDs) as backlight sources. LED backlight sources have two types: white LEDs and three-color (red,. green, and blue) LEDs. The drawback of white LEDs is high cost. Red, green, and blue LEDs are generally used in backlight modules. Red, green, and blue light respectively emitted from the red, green, and blue LEDs is merged to generate white light. In general, to determine whether the merged white light conforms to a predetermined standard, backlight modules adjust the red, green, and blue light respectively from the red, green, and blue LEDs using light-merging control units, thereby controlling chromaticity coordinates of the merged white light.

FIG. 1 shows a conventional light-merging control unit applied in a backlight module. The light-merging control unit comprises a red light detector 10R, a green light detector 10G, a blue light detector 10B, a light controller 11, a red light driver 12R, a green light driver 12G, a blue light driver 12B, and a luminance-setting unit 13. The luminance-setting unit 13 determines the intensity of the red, green, and blue light corresponding to predetermined chromaticity coordinates of the white light. A red LED LR, a green LED LG, and a blue LED LB of the backlight module BM are disposed on one side of a panel PL. The red light driver 12R, the green light driver 12G, and the blue light driver 12B drive the red LED LR, the green LED LG, and the blue LED LB respectively. Red, green, and blue light respectively emitted from the red LED LR, the green LED LG, and the blue LED LB is merged into white light by optical elements (not shown) of the backlight module.

In order to detect the intensity of the red, green, and blue light respectively from the red LED LR, the green LED LG, and the blue LED LB, a red filter 14R, a green filter 14G, and a blue filter 14B are respectively disposed on the front sides of the red light detector 10R, the green light detector 10G, and the blue light detector 10B. For example, after the merged white light passes through the red filter 14R, the green and blue light is intercepted by the red filter 14R, and the red light detector 10R detects only the red light and generates a red light detection signal SLOR. The light controller 11 receives the red detection signal S10_{R} to determine the intensity of the red light. The light controller 11 compares the determined intensity of the red light with the intensity of the red light corresponding to the predetermined chromaticity coordinates. The light controller 11 further outputs a red control signal S11_{R} according to the comparison result. The red driver 12R receives the red control signal S11_{R} and drives the red LED LR according to the red control signal S11_{R}. Similarly, detection and control of the intensity of the green and blue light follow the above description.

In the conventional light-merging control unit, however, the filters 14R, 14G, and 14B respectively disposed on the front sides of the detectors 10R, 10G, and 10B increase manufacture cost.

### SUMMARY

Light-merging control units are provided. An exemplary embodiment of a light-merging control unit is applied in a backlight module of a display device. The backlight module comprises a first light emitting unit driven by a first frequency and a second light emitting driven by a second frequency. Light from the first and second light emitting units is merged into merged light.

An exemplary embodiment of a light-merging control unit comprises a light detector, a controller, a first driver, and a second driver. The light detector detects the merged light and generates a detection signal. The controller calculates the power of the first and second frequencies according to the detection signal, generates a first control signal according to the difference between the power of the first frequency and a first predetermined frequency power, and generates a second control signal according to the difference between the power of the second frequency and a second predetermined frequency power. The first driver adjusts the power of the first frequency according to the first control signal. The second driver adjusts the power of the second frequency according to the second control signal.

### DESCRIPTION OF THE DRAWINGS

Light-merging control units will become more fully understood from the detailed description given hereinbelow and the accompanying drawings, given by way of illustration only and thus not intended to be limitative of the invention.

FIG. 1 shows a conventional light-merging control unit applied in a backlight module.

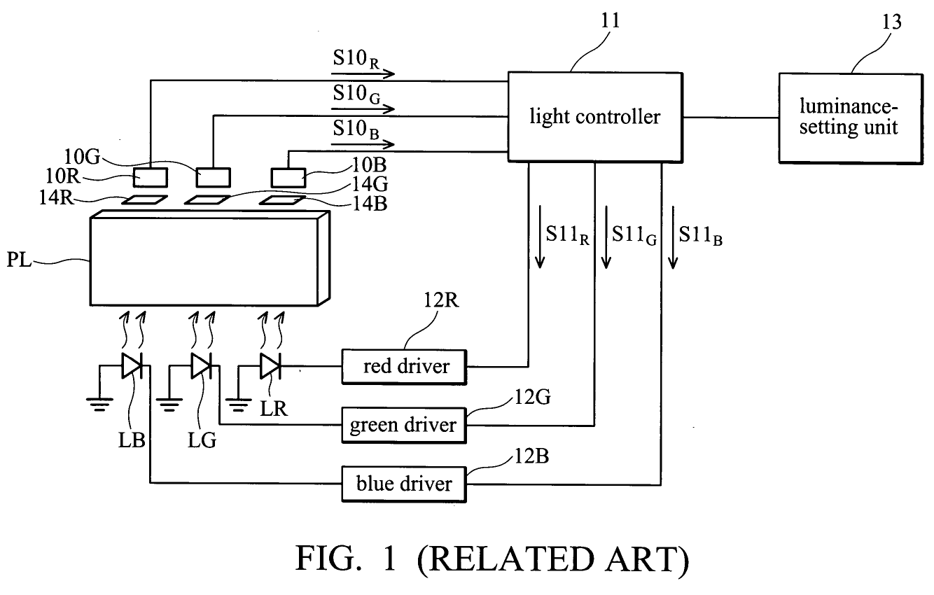

FIG. 2 shows an embodiment of a light-merging control.

### DETAILED DESCRIPTION

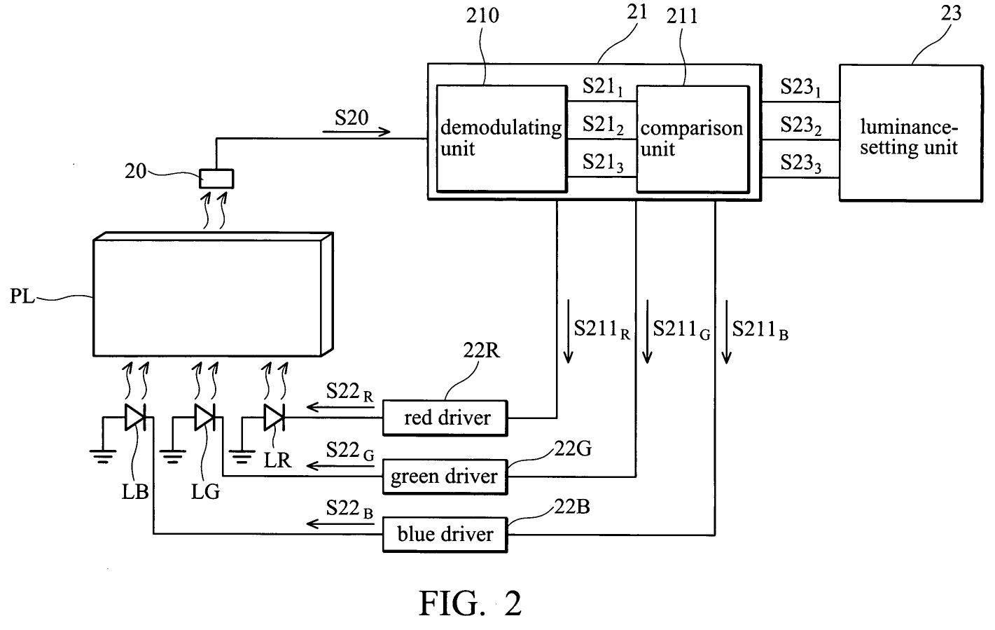

Light-merging control units are provided. In some embodiments, as shown in FIG. 2, a light-merging control unit is applied in a backlight module of a display device and comprises a light detector 20, a controller 21, a red light driver 22R, a green light driver 22G, a blue light driver 22B, and a luminance-setting unit 23. A red LED LR, a green LED LG, and a blue LED LB of the backlight module (not shown) are disposed on the underside of a panel PL.

The red light driver 22R drives the red LED LR by a driving signal S22_{R} carrying a first frequency. The green light driver 22G drives the green LED LG by a driving signal S22_{G} carrying a second frequency. The blue light driver 22B drives the green LED LB by a driving signal S22_{B} carrying a third frequency. In other words, the working frequencies of the red LED LR, the green LED LG, and the blue LED LB are the first, second, and third frequencies respectively. The first, second, and third frequencies are different, and the power thereof is associated with the intensity of the light. For example, the power of the first frequency is in direct proportion to the intensity of the red light from the ref LED LR. The red, green, and blue light respectively emitted from the red LED LR, the green LED LG, and the blue LED LB is merged into white light by optical elements (not shown) of the backlight module.

The luminance-setting unit 23 determines predetermined chromaticity coordinates in advance. The predetermined chromaticity coordinates indicate the predetermined intensity of the red, green, and blue light. Since the working frequencies of the red LED LR, the green LED LG, and the blue LED LB are different, the luminance-setting unit 23 can determine a first predetermined frequency power according to the predetermined intensity of the red light, a second predetermined frequency power according to the predetermined intensity of the green light, and a third predetermined frequency power according to the predetermined intensity of the blue light. In other words, the first, second, and third predetermined frequency powers represent the predetermined chromaticity coordinates.

The light detector 20 detects the merged white light to generate a detection signal S20. The controller receives the detection signal S20 and calculates the power of the first, second, and third frequencies. The controller 21 compares the power of the first frequency with the first predetermined frequency power and outputs a control signal S211_{R} according to the comparison result. The controller 21 compares the power of the second frequency with the second predetermined frequency power and outputs a control signal S211_{G} according to the comparison result. The controller 21 further compares the power of the third frequency with the third predetermined frequency power and outputs a control signal S211_{B} according to the comparison result.

The drivers 22R, 22G, and 22B drive the red LED LR, the green LED LG, and the blue LED LB according to the control signals S211_{R}, S211_{G}, and S211_{B}, respectively. The red driver 22R is given as an example. The red driver 22R receives the control signal S211_{R} and changes the power of the first frequency by adjusting the duty cycle of the driving signal S22_{R}. When the power of the first frequency is raised, the intensity of the red light emitted from the red LED LR is increased. When the power of the first frequency is lowered, the intensity of the red light emitted from the red LED LR is decreased. Similarly, the green driver 22G and the blue driver 22B perform the same operation as the red driver 22G.

Referring to FIG. 2, the control 21 and the luminance-setting unit 23 are described following in detail.

The controller 21 comprises a demodulating unit 210 and a comparison unit 211. The demodulating unit 210 receives the detection signal S21 and demodulates the detection signal S20 to get the first, second, third frequencies. The demodulating unit 210 further calculates the power of the demodulated first, second, third frequencies and generates a first power signal S21₁, a second power signal S21₂, and a third power signal S21₃ respectively representing the power of the demodulated first, second, third frequencies. The demodulating unit 210 determines the intensity of the red, green, and blue light according to the calculated power of the demodulated first, second, third frequencies. The chromaticity coordinates of the merging white light are obtain according to the intensity of the red, green, and blue light.

The luminance-setting unit 23 generates a first predetermined power signal S23₁, a second predetermined power signal S23₂, and a third predetermined power signal S23₃ respectively representing the first, second, third predetermined frequency power.

The comparison unit 211 receives the power signals S21₁ to S21₃ and the predetermined power signals S23₁ to S23₃. The comparison unit 211 compares the power signals S21₁ and S23₁ and outputs the control signal S211_{R} to the red driver 22R according to the comparison result. The controller 21 compares the power signals S21₂ and S23₂ and outputs the control signal S211_{G} to the green driver 22G according to the comparison result. The controller 21 compares the power signal S21₃ and S23₃ and outputs the control signal S211_{B} to the blue driver 22B according to the comparison result. In other words, the comparison unit 211 compares the chromaticity coordinates of the merged white light with the predetermined chromaticity coordinates to generate the control signals S211_{R}, S211_{G}, and S211_{B}.

In the embodiment, the red LED LR, the green LED LG, and the blue LED LB are driven by three different frequencies. The control 21 calculates the power of the three frequencies according to the detection signal S20 and further determines the intensity of the red, green, and blue light. If the intensity of the red, green, and blue light does not conform to a predetermined standard, the drivers 22R, 22G, and 22B adjust the power of the three frequencies respectively. Thus, according to the light-merging control unit of the embodiment, the light detector 20 can directly detect the merging white light without through filters.

While the invention has been described in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A light-merging control unit for a backlight module of a display device, the backlight module comprising a first light emitting unit driven by a first frequency and a second light emitting driven by a second frequency, with light from the first and second light emitting units merged into merged light, the light-merging control unit comprising:
a light detector detecting the merged light and generating a detection signal;
a controller calculating the power of the first and second frequencies according to the detection signal, generating a first control signal according to the difference between the power of the first frequency and a first predetermined frequency power, and generating a second control signal according to the difference between the power of the second frequency and a second predetermined frequency power;
a first driver adjusting the power of the first frequency according to the first control signal; and
a second driver adjusting the power of the second frequency according to the second control signal.

2. The light-merging control unit as claimed in claim 1, wherein the power of the first frequency is in direct proportion to the intensity of the light from the first light emitting unit, and the power of the second frequency is in direct proportion to the intensity of the light from the second light emitting unit.

3. The light-merging control unit as claimed in claim 2, wherein the first predetermined frequency power corresponds to the predetermined intensity of the light from the first light emitting unit, and the second predetermined frequency power corresponds to the predetermined intensity of the light from the second light emitting unit.

4. The light-merging control unit as claimed in claim 1 further comprising:
a demodulating unit demodulating the detection signal to get the first and second frequencies and calculating the power of the first and second frequencies, wherein the power of the first frequency corresponds to the intensity of the light from the first light emitting unit, and the power of the second frequency corresponds to the intensity of the light from the second light emitting unit; and
a comparison unit comparing the power of the first frequency with the first predetermined frequency power to generate the first control signal, and comparing the power of the second frequency with the second predetermined frequency power to generate the second control signal.

5. The light-merging control unit as claimed in claim 4, wherein the first predetermined frequency power corresponds to the predetermined intensity of the light from the first light emitting unit, and the second predetermined frequency power corresponds to the predetermined intensity of the light from the second light emitting unit.

6. The light-merging control unit as claimed in claim 5 further comprising a luminance-setting unit determining the predetermined intensity of the light from the first light emitting unit to set the first predetermined frequency power and determining the predetermined intensity of the light from the second light emitting unit to set the second predetermined frequency power.

7. A light-merging control unit for a backlight module of a display device, the backlight module comprising a red emitting unit driven by a first frequency, a green emitting unit driven by a second frequency, and a blue light emitting driven by a third frequency, light from the red, green, and blue light emitting units merged into white light, the light-merging control unit comprising:
a light detector sensing the white light and generating a detection signal;
a controller determining chromaticity coordinates of the white light according to the detection signal and outputting first, second, third control signals according to the difference between the chromaticity coordinates of the white light and predetermined chromaticity coordinates;
a first driver adjusting the power of the first frequency according to the first control signal, thereby adjusting the intensity of the light from the red emitting unit;
a second driver adjusting the power of the second frequency according to the second control signal, thereby adjusting the intensity of the light from the green emitting unit; and
a third driver adjusting the power of the third frequency according to the third control signal, thereby adjusting the intensity of the light from the blue emitting unit.

8. The light-merging control unit as claimed in claim 7 further comprising:
a demodulating unit demodulating the detection signal to get the first, second, and third frequencies and calculating the power of the first, second, and third frequencies, wherein the power of the first, second, and third frequencies correspond to the chromaticity coordinates of the white light; and
a comparison unit comparing the chromaticity coordinates of the white light and the predetermined chromaticity coordinates and outputting the first, second, third control signals according to the comparison result.

9. The light-merging control unit as claimed in claim 8, wherein the power of the first frequency corresponds to the intensity of the light from the red light emitting unit, the power of the second frequency corresponds to the intensity of the light from the green light emitting unit, and the power of the third frequency corresponds to the intensity of the light from the blue light emitting unit.

10. The light-merging control unit as claimed in claim 8, wherein the predetermined chromaticity coordinates correspond to first, second, and third predetermined frequency power.

11. The light-merging control unit as claimed in claim 10, wherein the comparison unit compares the power of the first frequency with the first predetermined frequency power, the power of the second frequency with the second predetermined frequency power, and the power of the third frequency with the third predetermined frequency power.
